(19) United States
(12) Patent Application Publication
(10) Pub. No.: US 2009/0105616 A1
(43) Pub. Date: Apr. 23, 2009

(54) Sustaining and prolonging life without dying, death, torture, reincarnation, or being reborn in the flesh

(76) Inventor: Larry Keith Reed, Mira Loma, CA (US)

Correspondence Address: Larry Keith Reed, 10587 Jurupa Rd., Mira Loma, CA, 91752, US

(21) Appl. No.: 11/757,381

(22) Filed: Oct. 17, 2007

(51) Int. Cl. A61H 1/00

(52) U.S. Cl. 601/1

(57) ABSTRACT

The following pages will present my invention and a method of using a soft cloth devise to sustain life without death, torture, reincarnation, or being reborn in the flesh of another by resurrection, etc.!

My invention and discovery presents a new method to manipulate the muscles and bone's within the human and mammal's body to sustain life. This unique medical invention and technique is capable of relieving the pressure and bone constriction that causes physical death to occur as the mammal or person grows older or becomes sick, etc!

The following information will describe and provide the related arts, a brief description of the drawings, and a claim to the invention created.

The drawings show the basic starting position of the hands and cloth.

The following invention will be lawfully available once the Medical Licensing Board approves it. And, the inventor secures a written agreement and legally assigns the physician or practitioner the right of use.

### FIELD OF THE INVENTION

The present invention relates generally to a unique new method and cloth devise to manipulate the bones and muscles with the human body unlike never before discovered or approved. The main advantages of my new invention when used in combination with a cloth devise is the ability to maneuver and align the surrounding tissue and muscles around the bones within the head, neck, shoulders, rib cage, spinal cord, circulatory system, and spinal column, etc.! Furthermore, when my invention is combined with a licensed Magnetic Resonance Imaging or X-Ray machine it can perfect the internal alignment of the muscles and bones to reduce the pressure and stretching on the circulatory system and vital organs to sustain human life by up to ten to twenty or more calendar years.

### BACKGROUND OF THE INVENTION AND DESCRIPTION OF THE RELATED ART

it can be appreciated that a number of different scientific and medical studies have been around for a number of years that have attempted to sustain good health and life. For Example: “Osteopathy,” was first developed during the 1870's by a doctor known as, “Mr. Andrew Taylor Still.” And, osteopathy is similar in regard to its theory and hypothesis in musculo-skeletal problems, disorders, and therapy, etc. . . . Furthermore, the medical science known as, “Chiropractic,” was founded by “Daniel D. Palmer,” dating back to the 1890 A.D. It is grounded in the principle that the body can heal itself when the skeletal system is correctly aligned and the nervous system is functioning properly. And, chiropractic is also from the Greek words meaning done by hand, However, while osteopathy and chiropractic techniques and therapy may be suitable of aligning a number of different vertebrae's and improving a number of different symptoms in musculoskeletal problems. They have never achieved the same ability as my unique invention. Furthermore, the related arts were not formerly taught in the same manner and are not capable of maneuvering and realigning the muscles in the same way within the skull bones, sinus bones, rib gage, shoulders, neck muscles, and the spinal cord within the spinal column, etc.! And, the most important difference about my medical invention is the related medical arts have never succeeded at preventing the eventual physical death of a human being or mammal in the same manner as I have created and invented.

### SUMMARY OF THE INVENTION

My unique medical invention and patent pending research and technique has expanded beyond the field of osteopathy and chiropractic abilities and the devises of the past. This invention has created a method of maneuvering a number of different areas of the muscles and bones that can sustain life without causing physical death!

Although, this unique technique and process would be more complete and comprehensible to describe by video and magnetic resonance imaging X-Rays and devise, I will try to describe how it involves the manipulation of the bones and muscles like they have never been know to move before within the skull, shoulders, rib cage, and spinal column, etc. . . . And, still yet a person stays conscious and their own health can be improved or sustained for a number of years after alignment. Another unique thing about this invention and process is that it creates the ability to maneuver the bones within the skull and body with a soft cloth that is moved in a slight circular or rotating motion underneath the fingertips and hands over the outside of the body.

### BRIEF DESCRIPTION OF DRAWINGS

### Drawings: P. 1 through P. 16

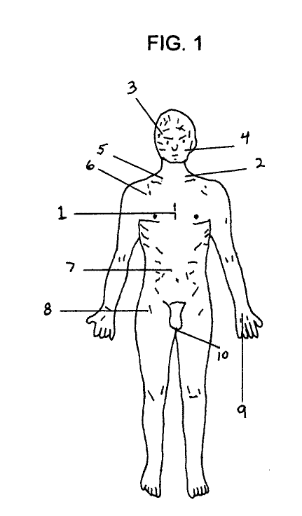

1. FIG. 1 shows several views and areas where the licensed physician or practitioner can place their hands and soft cloth devise on the patients body.

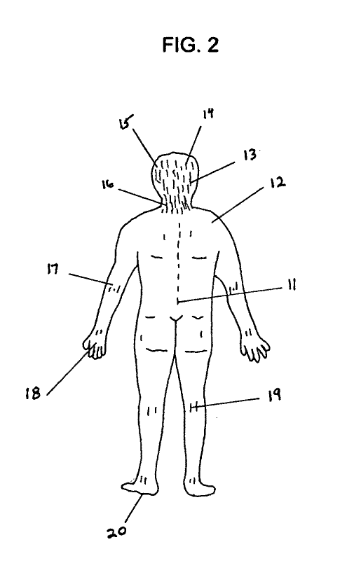

2. FIG. 2 shows a sketch of the back side of the human body.

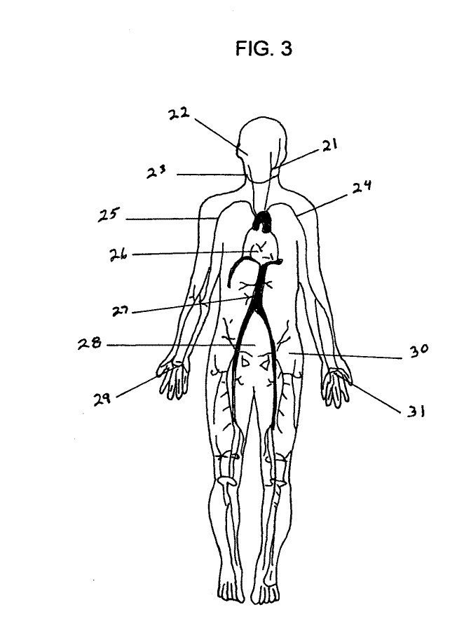

3. FIG. 3 is a sketch showing the human body with a brief map of the circulatory system.

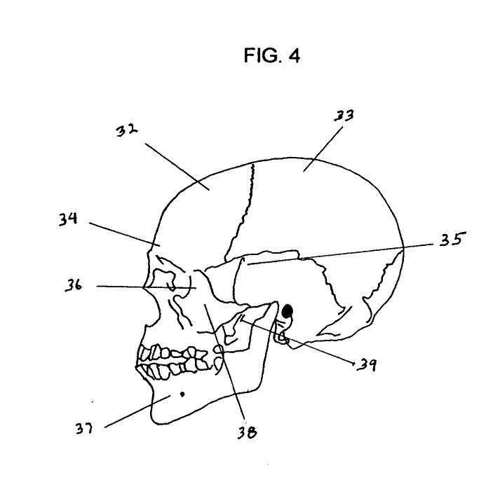

4. FIG. 4 is a side view of the human skull.

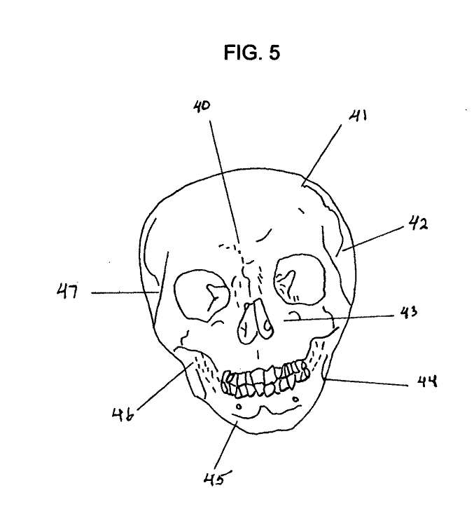

5. FIG. 5 shows a frontal view of the human skull.

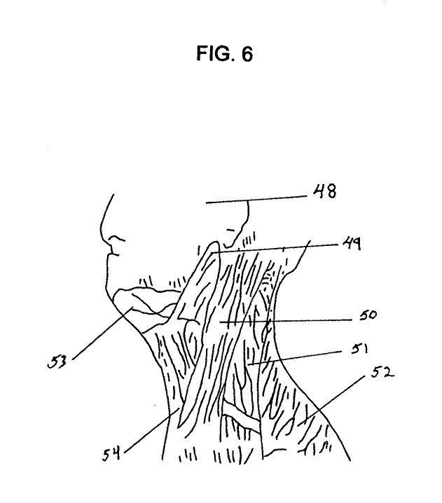

6. FIG. 6 is a sketch of the neck and facial muscles within the human body.

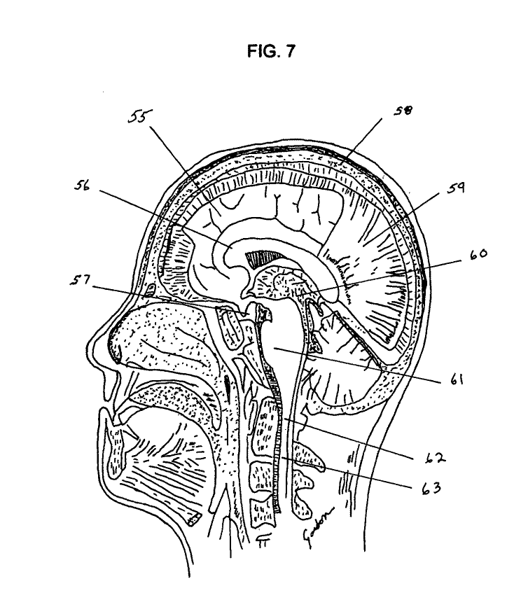

7. FIG. 7 shows a sketch showing a vague interior design of the human skull and brain.

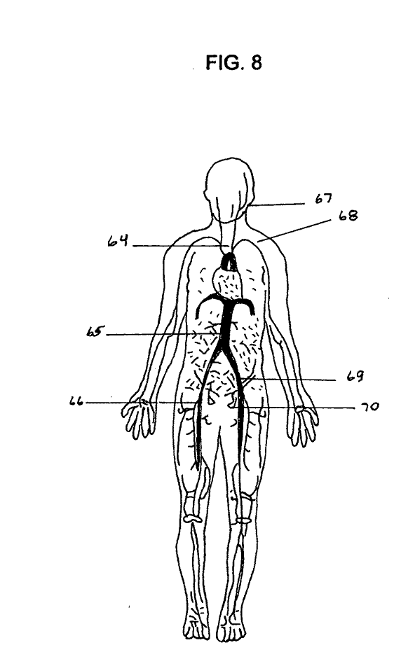

8. FIG. 8 shows a sketch of the basic position of the arteries within the human body.

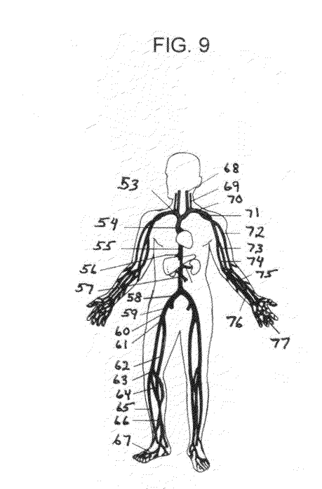

9. FIG. 9 is a vague outline of the veins within the human body.

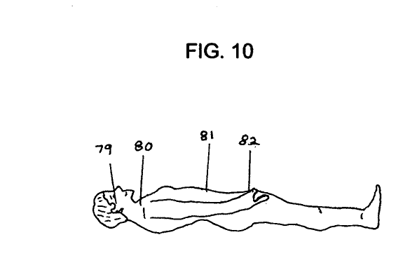

10. FIG. 10 is a sketch showing a person lying down on their back.

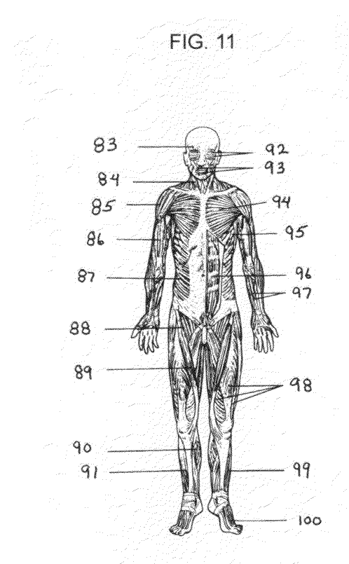

11. FIG. 11 is a front view of the muscles.

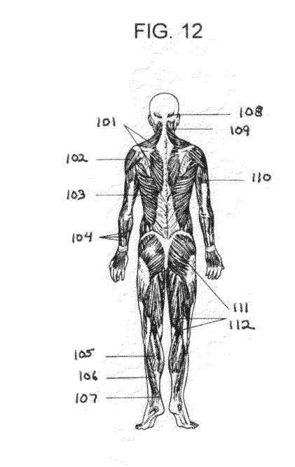

12. FIG. 12 shows a vague view of the back muscles.

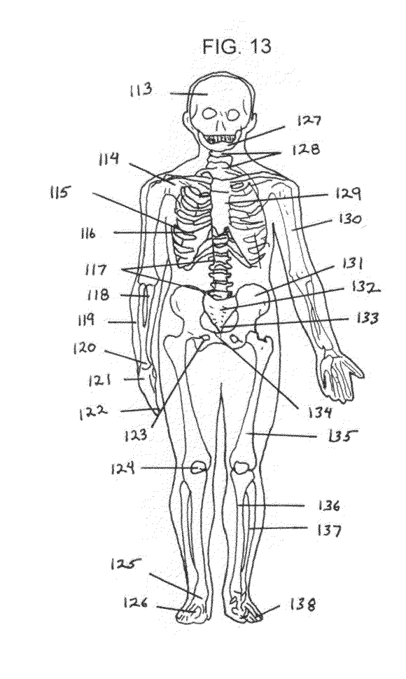

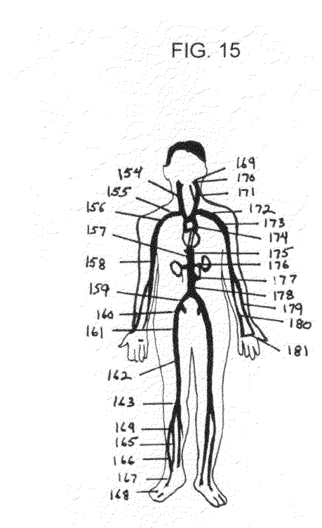

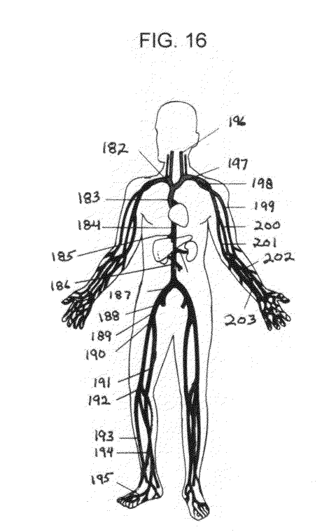

13. FIGS. 13 through 16 are sketches from a book by the United States Army Institute of Medicine software known as: “Basic Human Anatomy.”

### DESCRIPTION OF THE PREFERRED EMBODIMENT

The drawings show the basic placement of the hands and a soft cloth devise to maneuver and realign the muscles and bones with the fingertips. The contact points are number consecutively from 1 to 82. And each number represents where the right or left hand and fingertips will be approximately placed. However, it is important to remember that every movement achieved with my cloth devise and technique can either help a patient feel healthier! Or it could cause the patient to begin to become sick and die! So, it is vitally important the physician or practitioner makes sure to be gentle! And, before the physician or practitioner begins to start shifting anything within the patient they should first study and observe the patients Magnetic Resonance Images, CT Scans, or X-Rays. It also should be noted that in order for the physician or practitioner to really get the feel and physical movements complete they will need to be personally instructed, trained, and self practiced. FIGS. 11 through 16 are numbered in a consecutive manner and name the basic placement of the muscles, arteries, veins, and bones.

Note: I will put together a basic training video if necessary. However, I believe the drawings show where to basically begin.

FIG. 1 shows several views where the licensed physician or practitioner can place their hands and soft cloth devise on the patient's body. The placement of hands can also be used to practice by one's self. The patient will need to relax and trust in his or her physician to know what they are doing. Next, the licensed physician will need to examine the patients Magnetic Resonance Images, CT Scans, or X-Rays, to determine what direction to maneuver the muscles and bones. Then the physician will need to determine whether to move their hands in either a back, forth, push, pull, or circular manner. Once the physician has determined the area to be realigned he or she will gently slide over the patient's outer skin with the soft cloth while following the direction of the wrinkles of the cloth while it twirls and unwinds underneath the physicians fingertips and hands. Note: The natural swirl and rotation of the cloth and the movements underneath the hands has always reminded me of unwinding an over wound spring within a clock or unraveling a wound up towel. It also has always reminded me of trying to rearrange the colors to match one another within the colorful ball and block like puzzle made by, “Mattel Toys,” known as, “the Rubik Cube,” or, “Rubik Ball.”

FIG. 2 points to several more starting positions to shift and maneuver several areas within the chest, lower back, and skull bones.

FIG. 3 shows a vague sketch of the circulatory system and starting position to relieve the stretching and pinching that narrows the inside of the veins and arteries. Furthermore, the drawing points to several areas to relieve the pressure within the inside of the body and around the organs. It is important for the physician or practitioner to note that while a person's posture begins to become slumped or fatigued it will begin to pull upward and forward while stretching and pulling on the lower and top part of the insides of the whole of the brain and other muscles around the organs and bones within the spinal column, spinal cord, shoulders, and rib bones, etc.! Then the muscles will begin to pressure the arteries around the lower part of the neck bone, around the ears, upper sinus cavity, within the shoulder socket, around the heart, diaphragm, and the pelvis area, etc. . . .

FIGS. 4 and 5 is a side and frontal view of the skull. You will find out with this invention and discovery that every immovable section of the different skull bones can be maneuvered and realigned without causing much damage to any of the ligaments and bones.

FIG. 6 shows the various muscle strands that go up into the torso and around the shoulders and up into the neck and head. The physician or practitioner will need to learn how to manipulate each one of these muscles to reduce the pressure and pinching around and within the skull, jaw bone, sinuses, veins, arteries, torso, and up into the brain stem/cells, etc. . . .

FIG. 7 shows vaguely the various areas within the brain that during different periods of time they will need to be untwisted and relieved of pressure.

FIGS. 8 and 9 shows another drawing of the placement of the veins and arteries within the human body. The physician and practitioner should always remember that while pulling or sliding one muscle over another to never overstretch or pinch any of the main arteries, veins, nerve strands, or gristle, etc.! And, they should be especially careful to never over stretch or pressure any arteries, veins, or internal organs, while repositioning the skull, shoulders, or ribs bones. It also is very important whenever realigning the muscles around and within the rib bones to never forget the lungs or muscles around the heart may over tighten in one area or another and cause more problems for the health of your patient.

FIG. 10 is once again a person lying on their back.

Finally FIGS. 11 and 12 show the general placement of the outer muscles of the front and back side of the human body. However, with this invention it is always important to remember that most of the inner muscles can be manipulated easily with time. And, the physician or practitioner will need to manipulate and realign a number of different areas to un-pressure the circulatory system or organs to save the life of a dying person or mammal. Furthermore, you should always remember this invention and pending patent may look like it is only a form of a massage therapy. However, it is more like an outer and internal surgery! And, it could cause death to occur more rapidly if performed incorrect on a patient or mammal.

The remaining drawings are sketches from the United States Army Medical Department Center and School course known as, “Basic Anatomy by,” M. E. Turner. However, I overhear the sketches are part of the public domain. And, the drawings are common in most pictures and drawings that describe anatomy. But, they do provide the names of a number of different bones and muscles, etc. . . .

### LEGEND

Here is a list of various bones that my invention can easily manipulate the muscles around to relieve the pressure off the inside of a human being or mammal's circulatory system and vital organs.

The legend of bones and muscle groups are common in all human beings and biological drawings. And, I have already said my medical invention is similar in regard to a chiropractic and osteopathy theory. However, my theory and hypothesis is quite different and unique in its development, design, discoveries, and technique, etc. . . . ! Furthermore, this invention was developed from my very own research and theory. However, I had a strong believe in a Divine and true God! And, I believed strongly in the story tale of the return of Jesus Christ!

Please remember that my medical invention is so uniquely different in its design and discovery that I am capable of maneuvering and re-aligning the muscles and bones into a position to un-pressure the outside and inside of the brain, sinus cavity, temporal area, around the heart, lungs, throat, kidneys, and circulatory system, etc.! Reminder Note: Please remember this invention and technique can either improve a person or mammal's physical health. Or, it could cause a person to eventually die! So, it is very important for the practitioner or licensed physician to be properly trained and careful in determining the patients diagnoses and how to manipulate the muscles and bones within the patient.

### List of Muscles

### FIGS. 11 and 12.

| | |
|---|---|
| 83. | Frontalis |
| 84. | Sternocleidomastoid |
| 85. | Deltoid |
| 86. | Biceps Brachii |
| 87. | External Oblique |
| 88. | iliopsoas |
| 89. | Sartorius |
| 90. | Gastrocnemius |
| 91. | Tibialis Anterior |
| 92. | Orbicularis Oculi |
| 93. | Orbicularis Oris |
| 94. | Pectorialis Major |
| 95. | Serratus Anterior |
| 96. | Rectus Abdominis |
| 97. | Flexors |
| 98. | Quadriceps Femoris |
| 99. | Extensors |
| 100. | Extensor Tendons |
| 101. | Trapezius |
| 102. | Deltoid |
| 103. | Latissimus Dorsi |
| 104. | Extensors |
| 105. | Gastrocnemius |
| 106. | Soleus |
| 107. | Achille's Tendon |
| 108. | Occipitalis |
| 109. | Sternocleidomastoid |
| 110. | Triceps Brachii |
| 111. | Gluteus Maximus |
| 112. | Hamstrings |

### List of Human Bones

### FIG. 13

| | |
|---|---|
| 113 | Skull |
| 114. | Scapula |
| 115. | Rib |
| 116. | Costal Cartilage |
| 117. | Lumbar Vertebrae |
| 118. | Ulna |
| 119. | Radius |
| 120. | Carpal Bones |
| 121. | Metacarpal Bones |
| 122. | Phalanges |
| 123. | Ischium |
| 124. | Patella |
| 125. | Tarsal Bones |
| 126. | Metatarsal Bones |
| 127. | Mandible |
| 128. | Cervical Vertebrae |
| 129. | Stemum |
| 130. | Humerus |
| 131. | Ilium |
| 132. | Sacrum |
| 133. | Coccyx |
| 134. | Pubis |
| 135. | Femur |
| 136. | Tibia |
| 137. | Fibula |
| 138. | Phalanges |

### Back View of Human Bones

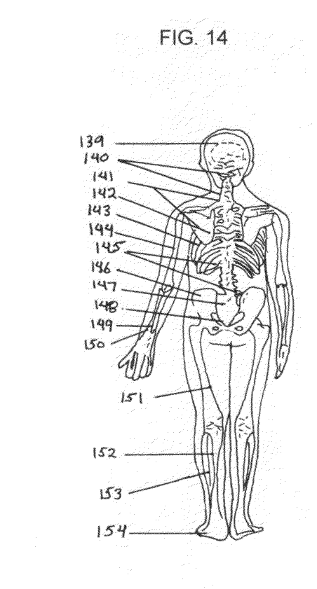

### FIG. 14

139. Skull
140. Cervical Vertebrae
141. Thoracic Vertebrae
142. Scapula
143. Rib
144. Humerus
145. Lumbar Vertebrae
146. ilium
147. Sacrum
148. Coccyx
149. Ulna
150. Radius
151. Femur
152. Tibia
153. Fibula
154. Calcaneus

### List of Arteries

The following legend shows a vague location of the main arteries that can be relieved when using my Cloth Devise and technique in a slight circular motion. However, I did not show every artery and vein inside the skull. And, the physician or practitioner will need to manipulate the cloth devise in various ways to achieve the best results.

### List of Arteries

| | |
|---|---|
| 154. | Right Vertebral |
| 155. | Braciocephalic |
| 156. | Axillary |
| 157. | Superior Mesenteric |
| 158. | Brachial |
| 159. | Right Common iliac |
| 160. | Internal iliac |
| 161. | External iliac |
| 162. | Femoral |
| 163. | Popliteal |
| 164. | Peroneal |
| 165. | Anterior Tibial |
| 166. | Posterior Tibial |
| 167. | Dorsalis Pedis |
| 168. | Arcuate |
| 169. | External Carotid |
| 170. | Internal Carotid |
| 171. | Common Carotid |
| 172. | Left Subclavian |
| 173. | Axillary |
| 174. | Thoracic Aorta |
| 175. | Celiac Axis |
| 176. | Renal |
| 178. | Inferior Mesenteric |
| 179. | Abdominal Aorta |
| 180. | Radial |
| 181. | Ulnar/Palmer Arch |

### List of Veins

The following list shows where the main veins are basically located in the human body.

| | |
|---|---|
| 182. | Brachiocephalic |
| 183. | Superior Vena Cava |
| 184. | Inferior Vena Cava |
| 185. | Hepatic |
| 186. | Hepatic Portal |
| 187. | Common iliac |
| 188. | Internal iliac |
| 189. | External iliac |
| 190. | Femoral |
| 191. | Great Saphenous |
| 192 | Popliteal |
| 193. | Anterior Timal |
| 194. | Small Saphenous |
| 195. | Dorsal Venous Arch |
| 196. | Interal Jugular |
| 197. | Subclavian |
| 198. | Axillary |
| 199. | Cephalic |
| 200. | Brachial |
| 201. | Basilic |
| 203. | Cephalic |
| 204. | Basilic |

Note: I believe one of my most important realizations and discoveries is how the arteries and veins tend to stretch and pull within the human and mammal's body. The arteries and veins will stretch and pull until the center of the tube begins to narrow and close. And, the stretching is caused by a person's weight and their muscles constricting and pulling over and through the bones while eventually constricting the skeletal system out of posture as a person or mammal grows tense, older, or fatigued. Then the cholesterol or fatty tissue will begin to stick more often to the sides of the arteries or vein like moss growing on the side of a streambed; or on the side of a water pond when no water is running or rinsing over it. I also theorize that various forms of cancers tend to develop from one organ or another becoming overly pressured and swollen while up against a muscle wall or different organ. Then the overly pressured organ begins to internally constrict and then begins to excrete serum or its own production into the blood stream and onto another organ until a mutation develops.

I claim as my invention the ability to relieve and reduce the stretching and pressure that develops eventually within and around the human and mammal's vital organs and circulatory system, etc. . . .

1. I also claim my invention can improve the physical health and sustain a human being or mammal's life by manipulating and realigning the muscles and immovable joints within and around the skeletal system with a soft cloth devise that is slightly rotated with the hands and fingertips. And, this invention can relieve and reduce the stretching and pressure that develops within and around the inside of the heart and brain, etc.!Furthermore, my medical invention is capable of reducing the stretching and constriction that develops around and within the skeletal system that causes a reduction in the flow of blood through the circulatory system that will eventually cause death to occur to most mammals and human beings.
I also claim to be the first person to personally decipher and create a method to manipulate and re-align the muscles and skeletal structure by using a soft cloth devise that is slightly rotated underneath the fingertips to safely shift the muscles and bones into a more healthy state of physical health.
I also claim to be the first person to safely maneuver the immovable joints and ligaments within the skull and upper and lower torso with a soft cloth devise and fingertips, etc. . . .
My invention can reduce the muscle and bone constriction that causes an internal brain hemorrhage or stroke by manipulating and realigning the immovable joints and solid bone. And, I also claim to be one of the first persons to develop a method to realign the spinal column with a technique that maneuvers the spine and muscles in a slight circular manner to relieve pressure within the lower back vertebras, behind the heart muscle, and up into the inside of the brain, etc. . . .
I claim my research and invention can reduce and relieve the pressure and muscle constriction that pulls the posture within the human being or mammal's physical body out of alignment and causes pressure and squeezing around and within the skull, sinus cavity, temporal bones, cheeks, ears, circulatory system, rib gage, chest cavity, lungs, liver, kidneys, shoulders, spinal column, the pelvis area, and inside and around the brain. Furthermore, I have personally researched and deciphered how to realign and relieve the pressure within the chest and skull that causes the body's circulatory system to become so pinched and constricted that the human body cannot produce enough blood or oxygen to the brain and heart muscle. Then the muscles and organs become so pressured and pinched that the heart stops pumping or the brain becomes unconscious. Important Note: Please remember I have never killed or caused the physical death of any person or human being with my medical invention. Furthermore, I have never completely physically died during my research and development. However, I have researched and personally suffered most of the physical symptoms that cause most people to physically die. And, I am certain my theory and hypothesis is correct.
